(19) United States
(12) Patent Application Publication
(10) Pub. No.: US 2021/0180288 A1
(43) Pub. Date: Jun. 17, 2021

(54) DEBRIS GRIPPER AND EXTRACTOR FOR HYDRAULIC EQUIPMENT

(71) Applicant: BERTHA MANUFACTURING, LLC, Hicksville, OH (US)

(72) Inventor: Jeffrey J. PETER, Hicksville, OH (US)

(21) Appl. No.: 17/187,485

(22) Filed: Feb. 26, 2021

Related U.S. Application Data
(63) Continuation of application No. 15/605,306, filed on May 25, 2017, now abandoned.
(60) Provisional application No. 62/342,145, filed on May 26, 2016.

(51) Int. Cl. E02F 3/40; E02F 3/96; E02F 3/413

(52) U.S. Cl. CPC E02F 3/404; B60Y 2200/412; E02F 3/4135; E02F 3/962

(57) ABSTRACT

Attachments for excavators and the like for improved gripping, handling, and processing of materials and debris are provided having one or more work surfaces to provide enhanced material handling characteristics.

### CROSS-REFERENCE TO RELATED APPLICATIONS

The present application is Continuation application and claims priority to U.S. Utility patent application Ser. No. 15/605,306 filed on May 25, 2017 and U.S. Provisional Patent Application No. 62/342,145 filed on May 26, 2016, the disclosures of which are incorporated herein by reference.

### BACKGROUND

Large scale earth excavation operations are typically performed using a powered excavating apparatus, such as a tracked excavator, having an articulated, hydraulically pivotable boom structure with an elongated, pivotal outer end portion or arm. Secured to the outer end of the arm is an excavating bucket, which is hydraulically pivotable relative to the arm between “closed” and “open” positions. By pivotally manipulating the arm, with the bucket swung to a selected operating position, the excavator operator uses the bucket to forcibly dig into the ground, scoop up a quantity of dirt, and move the scooped up dirt quantity to another location, such as into the bed of an appropriately positioned dump truck.

Such backhoe or excavator arrangements are of limited utility when performing tasks other than digging or loading soil or other loose materials. They have a limited ability to lift, move, or transfer other objects such as rocks, logs, pipes, and debris using only the standard bucket attachment. What is needed is an improved grappling attachment for an excavator or backhoe arm.

### BRIEF DESCRIPTION OF THE DRAWINGS

FIG. 1 is a perspective view of one example of a grappling attachment according to the disclosed technology.

FIG. 2 is a view of the gripping portion of the grappling attachment shown in FIG. 1.

FIG. 3 is a view of the grappling attachment of FIG. 1.

FIG. 4 is a grappling attachment according to one example of the disclosed technology attached to an excavator.

FIG. 5 is a grapping attachment according to another example of the disclosed technology attached to an excavator arm.

FIG. 6 is a grapping attachment according to still another example of the disclosed technology attached to an excavator arm.

FIG. 7 is a grapping attachment according to another example of the disclosed technology attached to an excavator.

FIG. 8 is a view of a gripping portion of a grappling attachment according to the disclosed technology.

### DESCRIPTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would normally occur to one skilled in the art to which the claimed technology relates.

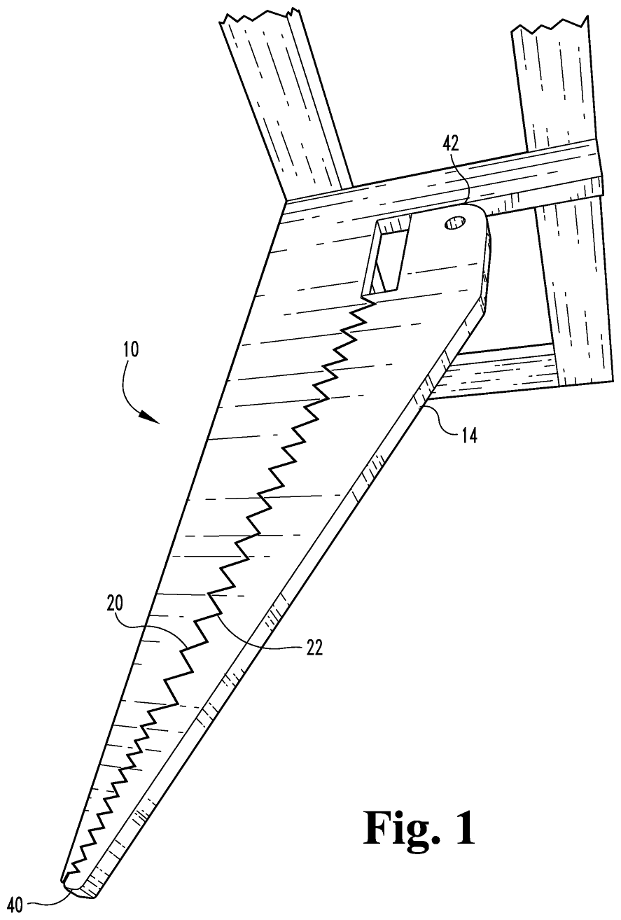

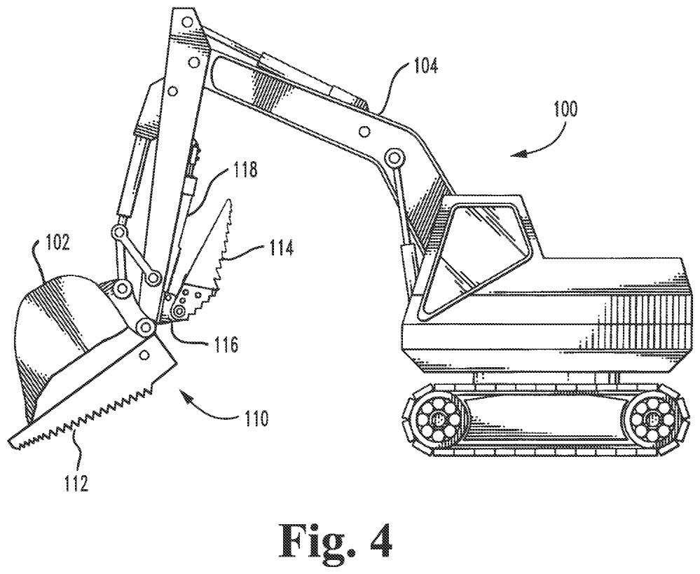

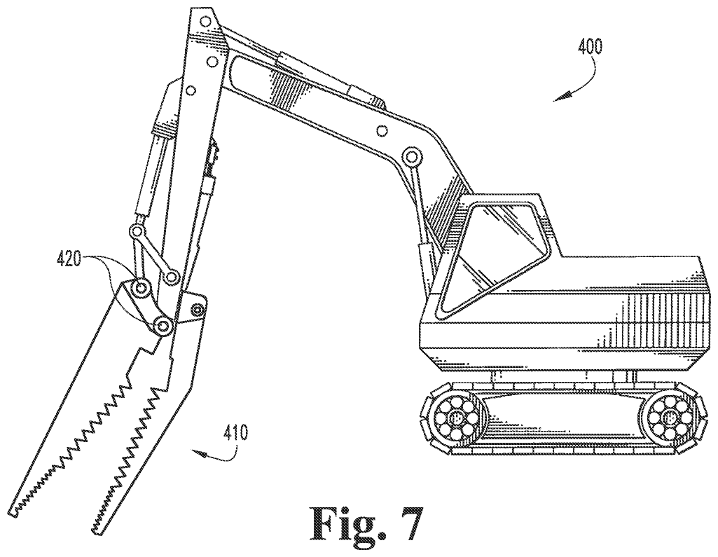

FIG. 1 shows a perspective view of a grappling attachment 10 for a backhoe or excavator according to one example of the disclosed technology. In this particular example, the grappling attachment 110 is designed to be attached to an existing bucket structure on an excavator 100 such as is shown in FIG. 4. In other examples, the grappling attachment 410 can be designed to be attached to the normal bucket attachment points 420 of an excavator 400 after the bucket has been removed such as is shown in FIG. 7.

In the example shown in FIGS. 1-3, the grappling attachment 10 includes a bucket portion 12 which is mounted to the existing bucket of an excavator and an opposable finger portion 14 which is operationally connected to a hydraulic ram. In one example, the bucket portion 12 is held steady using the excavator's hydraulics while the finger portion 14 is pivotably moved using a hydraulic ram to grasp or grip items such as logs, lumber, rocks, construction debris, and the like. In another example, the bucket portion 12 is pivotably moved relative to the finger portion 14 while the finger portion 14 is held steady. In still other examples, both the bucket portion 12 and the finger portion 14 may be movable relative to one another. Optionally, one or both portions are lockable into a desired position relative to one another. In certain applications it may be desirable to be able to selectively move one or both of the bucket and finger portions, for example, when picking through debris and trying to grasp and move only certain items in a debris pile.

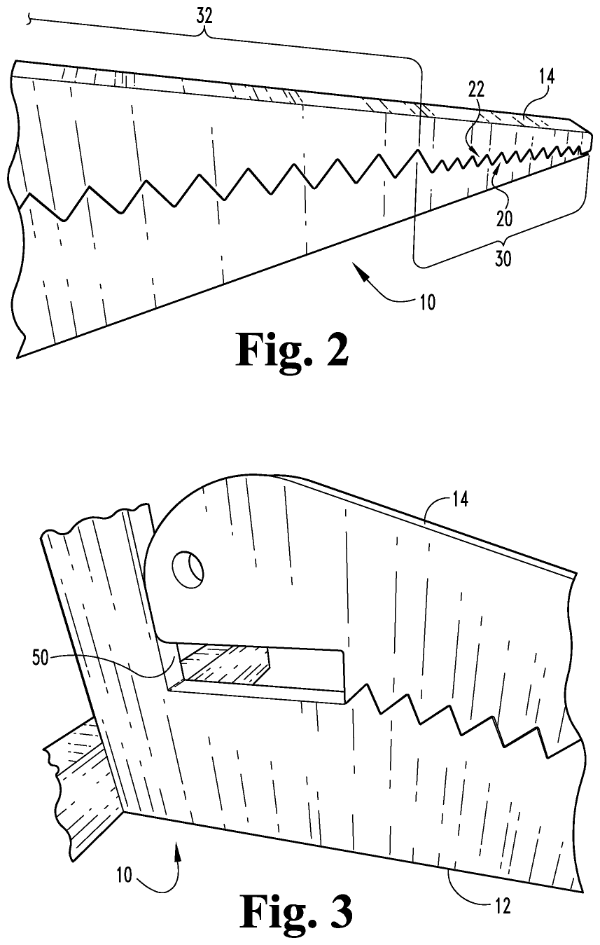

The finger portion 14 and the bucket portion 12 of the grappling attachment 10 include complementary toothed surfaces 20, 22 which interlock when the attachment is closed as shown in FIG. 1. The exact angle, depth, and number of teeth may differ across examples of the disclosed technology. In this particular example, a portion of the grappling attachment has relatively shallow and close together teeth 30 near the distal tip 40 of the device as seen in FIG. 2. The teeth closer 32 to the proximate end 42 of the device are larger and deeper as shown in FIG. 3. In other examples, the size and spacing of the teeth may be consistent across the entire working surface of the device. Optionally, a section of the teeth may be omitted and replaced with a sharpened surface on one or both sides for cutting debris. In other examples, one or more surfaces of either or both of the bucket portion and finger portion may include sharpened surfaces to act as sheers for cutting debris.

Continuing with FIGS. 1-3, the grappling attachment 10 in this example includes a pass through 50 or opening formed when the finger portion 14 and bucket portion 12 are closed together. In this example, the opening 50 is formed by a notch or cut out portion in each of the finger portion 14 and the bucket portion 12. This opening 50 may be used to grasp and lift items which might be crushed if handled too aggressively using the gripping teeth 20, 22 of the device. In other examples, one or both sides of the opening 50 may include a sharpened or sheering surface for cutting materials.

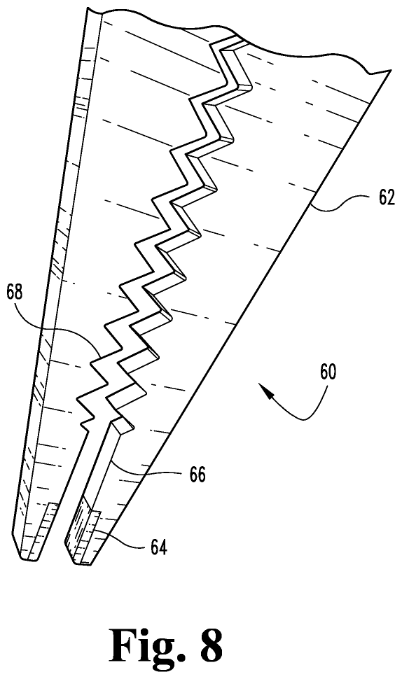

FIG. 8 shows a portion of the working surfaces of a grappling attachment 60 according to another example of the disclosed technology. In this example, the distal end 62 of the tool has three different types of work areas including a sharpened/cutting portion 64, a flat portion 66, and an interlocking toothed portion 68. Each portion of the tool may be used to perform a different task. For example, the sharpened portion 64 may be used to cut a piece of debris down to a more maneuverable size, the flat portion 66 may be used to reduce marring of the surface of an object while grasping it with the tool, and the toothed surface 68 may be used to increase grip strength of the tool. Other examples of the disclosed technology include tools which use one of more of these different work surfaces in different combinations, locations, and sizes relative to one another.

As shown in FIG. 4, the bucket portion 112 of the grappling device 110 may be attached to an existing bucket 102 of an excavator 100. Control and movement of this portion of the grappling device 110 is done using the existing hydraulics and operator controls for the bucket. The finger portion 114 of the device is mounted to the excavator support arm 104 using a mounting bracket 116 and moved and controlled using an additional hydraulic ram 118. The exact size and configuration of a mounting bracket will vary according to the make, model, configuration, and the like of a particular excavator. The other controls and movement for the excavator are unchanged from normal operation for a particular machine.

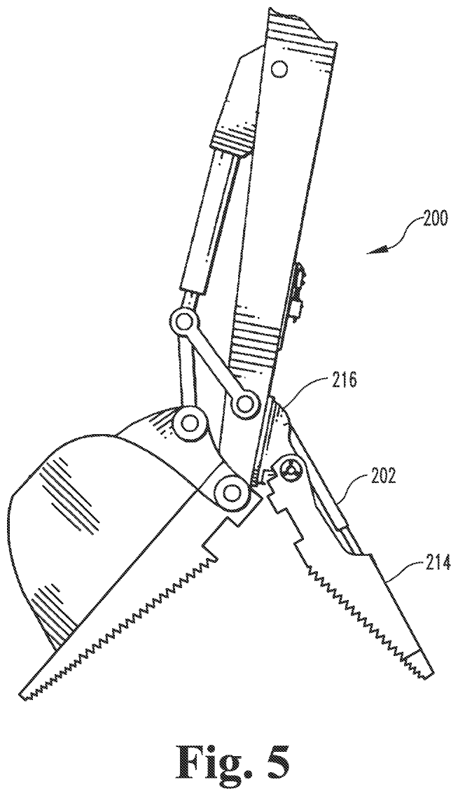

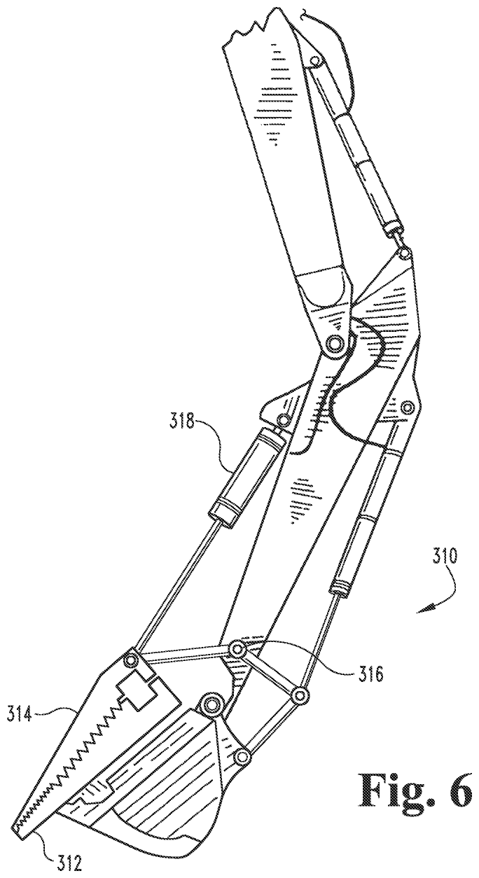

The grappling device 200 shown in FIG. 5, the hydraulic ram 202 used to move and control the finger portion 214 may be incorporated directly into the mounting bracket 216 and/or finger portion. In this particular view, the device is shown with the finger portion and bucket portion in an open position. The distance between the finger and bucket portions in an open position may differ between examples depending on the nature and configuration of the excavator being used, the configuration of the particular grappling device, and the like. As shown in FIG. 6, an existing hydraulic ram 318 and/or mounting point 316 may also be used for both the finger portion 314 and bucket portion 312 of the grappling device 310. In this view, the grapping device is shown with the finger portion and bucket portion contacting one another in a closed position. In another embodiment, the bucket may be removed and the grappling device 410 mounted, in whole or in part, to the normal bucket mounting points 420 of an excavator 400 such as shown in FIG. 7. The exact configuration of a suitable mounting bracket will vary according to the make, model, and the like of the excavator being used.

In still other examples, one portion may be fixably mounted to an excavating machine using a mounting bracket while the other portion is pivotably movable relative to the fixed portion using an existing hydraulic ram. For example, the finger portion may be mounted to the excavator arm using a mounting bracket and the bucket portion may be mounted to the excavator bucket which is pivotable relative to the finger portion using the existing excavator hydraulics and controls.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1. A gripping device for an excavator, the excavator having at least one mounting point, the gripping device comprising:
an arm mounting bracket adapted for mounting to a mounting point of an excavator;
a first finger portion pivotably mounted to the mounting point of the excavator and having at least one work surface;
a second finger portion pivotably mounted to the mounting point of the excavator and having at least one work surface;
wherein the first finger portion and the second finger portion are independently movable between an open position and a closed position;
wherein the first finger portion work surface and the second finger portion work surface contact one another in the closed position.

2. The device of claim 1, wherein at least one of the first finger portion work surface and the second finger portion work surface are toothed.

3. The device of claim 2, wherein at least one of the first finger portion work surface and the second finger portion work surface are sharpened.

4. The device of claim 1, wherein the first finger portion and the second finger portion each include a second work surface.

5. The device of claim 1, wherein at least one of the first finger portion and the second finger portion is pivotable using an existing hydraulic ram of the excavator.

6. The device of claim 1, wherein both the first finger portion and the second finger portion are pivotable using an existing hydraulic ram of the excavator.

7. The device of claim 1, wherein the first finger portion further comprises a first notched portion and the second finger portion further comprises a second notched portion, the first and second notched portions forming an opening when the first finger portion contacts the second finger portion.

8. A gripping device for an excavator, comprising:
an arm mounting bracket adapted for mounting to an arm portion of an excavator;
a first finger portion made of a single plate pivotably mounted to the arm mounting bracket and having at least one work surface; and
a second finger portion made of a single plate pivotably mounted to the bucket mounting bracket and having at least one work surface;
wherein the first and second finger portions are independently movable between an open position and a closed position;
wherein the first and second finger portion work surfaces contact one another in the closed position.

9. The device of claim 13, wherein the first and second finger portion work surfaces are toothed.

10. The device of claim 13, wherein the first and second finger portion work surfaces are sharpened.

11. The device of claim 13, wherein the first and second finger portions each include a second work surface.

12. The attachment of claim 13, wherein the first and second finger portions are pivotable using an existing hydraulic ram of the excavator.

13. The attachment of claim 13, wherein the first finger portion further comprises a first notched portion and the second finger portion further comprises a second notched portion, the two notched portions forming an opening when the first and second finger portions contact.
